(19) United States
(12) Patent Application Publication
(10) Pub. No.: US 2026/0302827 A1
(43) Pub. Date: Oct. 1, 2026

(54) FLEXIBLE POWERING ARCHITECTURES

(71) Applicant: ALPHA TECHNOLOGIES LTD., Burnaby (CA)

(72) Inventors: Peter Ksiazek, Burnaby (CA); Rahul Khandekar, Burnaby (CA); Thanh Le, Burnaby (CA); Jonathan Carpenter, Burnaby (CA)

(73) Assignee: ALPHA TECHNOLOGIES LTD., Burnaby (CA)

(21) Appl. No.: 19/089,643

(22) Filed: Mar. 25, 2025

(51) Int. Cl. H02J 9/06; H02J 7/00; H02J 7/02; H02J 7/34; H02M 1/42; H02M 1/44; H02M 3/00; H02M 3/335; H02M 7/493; H02M 7/5387

(52) U.S. Cl. CPC H02J 9/062; H02J 7/02; H02J 7/345; H02J 7/855; H02M 1/4233; H02M 1/44; H02M 3/01; H02M 3/33573; H02M 3/33592; H02M 7/493; H02M 7/53871; H02J 2207/20; H02J 2207/50

(57) ABSTRACT

A power converter apparatus for providing power to a load is disclosed. The power converter apparatus may comprise a first converter apparatus. The first converter apparatus may comprise a first port configured to be detachably coupled to a first power source. A first converter may be configured to convert power from the first power source to a first DC voltage. A second converter may be configured to convert the first DC voltage to a second DC voltage and an energy buffer may be configured to regulate the second DC voltage. An output converter may be configured to generate an output power signal based on the regulated second DC voltage. The output converter may be coupled to a second port that may be detachably coupled to the load.

### FIELD OF INVENTION

The present disclosure relates generally to power systems and, more particularly to power converter or supply systems having flexible architectures.

### BACKGROUND

This background description is provided for the purpose of generally presenting the context of the disclosure. Unless otherwise indicated herein, material described in this section is neither expressly nor impliedly admitted to be prior art to the present disclosure or the appended claims.

Power supply systems, such as uninterruptible power supplies (UPS's), have long been used to provide at least temporary auxiliary power to a load. Typically, a UPS is configured to switch between a primary power source and a standby power source as necessary to maintain constant power to the load. The primary power source for a UPS is typically a utility power supply and the standby power source may take the form of a battery system. The UPS will normally operate in a line mode in which the utility power signal is passed to the load when the utility power signal is within predefined parameters. In the line mode, the UPS will typically also charge the battery system. If the utility power falls outside of the predefined parameters, the UPS may switch to standby mode in which an AC signal is generated based on the energy stored in the battery system.

A class of UPS's employs a ferroresonant transformer. A ferroresonant transformer is a saturating transformer that employs a tank circuit which includes a resonant winding and a capacitor to produce a nearly constant average output even if the input to the transformer varies. A typical UPS employing a ferroresonant transformer takes advantage of the voltage regulating properties of a ferroresonant transformer in both line and standby modes. Due to the nature of the voltage regulating properties of the ferroresonant transformer, the output section of the transformer may be allowed to saturate and burn energy due to core and winding losses which cause the transformer to be very inefficient at no load. In the context of a UPS, a ferroresonant transformer may thus provide surge suppression, isolation, short circuit protection, and/or voltage regulation without the use of active components,

Conventionally, in battery/inverter mode, a UPS employs an inverter circuit configured to form a switch mode power supply. The switch mode power supply typically includes at least one and typically a plurality of power switches that are operated according to a pulse-width modulated (PWM) signal. PWM generation of an AC signal from a DC source allows the amplitude of the AC signal to be determined at any point in time by controlling the duty cycle at which the inverter power switches are operated. Controlling the duty cycle at which the inverter power switches are operated produces, through an output LC filter, a desired net average voltage. Typically, the parameters of the inverter control signal are varied according to a control signal generated by a feedback loop having an input formed by at least one characteristic, such as voltage, of the AC signal.

In a switch mode power supply, loss of efficiency may arise from imperfect switching characteristics of power switches during the transition between the ON and OFF configurations of the power switches. Another cause of efficiency loss in a switch mode power supply may arise from conduction loss. Conduction loss is typically associated with current flows in the switches of the switch mode power supply such that the conduction loss increases as the current through the switch increases. Therefore, it may be desired to provide improved power converter or supply systems with improved efficiency. It may also be desired to provide power converter or supply systems with flexible architectures that can be readily adapted for use in powering loads with different voltage requirements and/or standards,

### SUMMARY

The present disclosure relates to power converter or supply systems. The power converter systems may provide a cost effective and highly reliable solution for powering a load. The power converter systems may be configured to transfer power from a first power source or a second power source to the load. The first power source may be an AC power source and the second power source may be a DC power source. The power converter systems may have a flexible or modular architecture that can be adapted to accommodate power requirements for different loads. The power converter systems may include a first module, device, or unit that can be easily and quickly coupled to the first power source and a second module, device, or unit that may be easily and quickly coupled to the second power source. The second module, device, or unit may be separate from or combined with the first module, device, or unit. The first module, device, or unit may generate an output power signal that can have various polarities and waveshapes to meet the voltage/power requirements of the different loads, such as broadband networks, cable networks, etc.

In one aspect, a power converter apparatus for providing power to a load is disclosed. The power converter apparatus may be or include a first converter apparatus. The first converter apparatus may be or include a first port configured to be detachably coupled to a first power source and a first converter operatively coupled to the first port. The first converter may be configured to convert power from the first power source to a first DC voltage. The first converter apparatus may also include a second converter operatively coupled to the first converter. The second converter may be configured to convert the first DC voltage to a second DC voltage. Further, the first converter apparatus may include an energy buffer operatively coupled to the second converter. The energy buffer may be configured to regulate the second DC voltage. In addition, the first converter apparatus may include an output converter operatively connected to the energy buffer. The output converter may be configured to generate an output power signal based on the regulated second DC voltage. The first converter apparatus may also include a second port coupled to the output converter. The second port may be configured to be detachably coupled to the load.

In another aspect, a power converter apparatus for providing power to a load is disclosed. The power converter apparatus may include a first converter apparatus and a second converter apparatus. The first converter apparatus may be or include an energy buffer configured to output a first DC voltage and an output converter operatively coupled to the energy buffer. The output converter may be configured to generate an output power signal based on the first DC voltage. The first converter apparatus may also include a first port operatively coupled to the energy buffer. The second converter apparatus may be or include a first converter configured to convert an input power voltage to a second DC voltage and a first port configured to be coupled to the first port of the first converter apparatus.

The foregoing summary is illustrative only and is not intended to be in any way limiting. In addition to the illustrative aspects, embodiments, and features described above, further aspects, embodiments, and features will become apparent by reference to the figures and the following detailed description.

### BRIEF DESCRIPTION OF THE DRAWINGS

FIG. 1 illustrates a simplified block diagram of a power system, according to an exemplary embodiment;

FIG. 2 illustrates a block diagram of the components of a power converter system, according to an exemplary embodiment; and

FIG. 3 illustrates a detailed circuit diagram of a power converter system, according to an exemplary embodiment.

### DETAILED DESCRIPTION

Before explaining the embodiments in detail, it should be noted that the present disclosure is not limited in its application or use to the details of construction and arrangement of parts illustrated in the accompanying drawings and description, because the illustrative embodiments may be implemented or incorporated in other embodiments, variations and modifications, and may be practiced or carried out in various ways. Furthermore, unless otherwise indicated, the terms and expressions employed herein have been chosen for the purpose of describing the embodiments of the present disclosure for the convenience of the reader and are not for the purpose of limitation.

Embodiments described herein relate to power converter or supply systems. The power converter systems may have the advantage of providing a cost effective and highly reliable solution for powering a load. The power converter systems may be configured to transfer power from a first power source or a second power source to the load. The first power source may be an AC power source and the second power source may be a DC power source. The power converter systems may have a flexible or modular architecture that can be adapted to accommodate power requirements for different loads. The power converter systems may include a first module, device, and/or unit that can be easily and quickly coupled to the first power source and a second module, device, and/or unit that may be easily and quickly coupled to the second power source. The second module, device, and/or unit may be separate from or combined with the first module, device, and/or unit. The power converter systems may generate an output power signal that can have various polarities and waveshapes to meet the voltage/power requirements of the different loads, such as broadband networks, cable networks, etc.

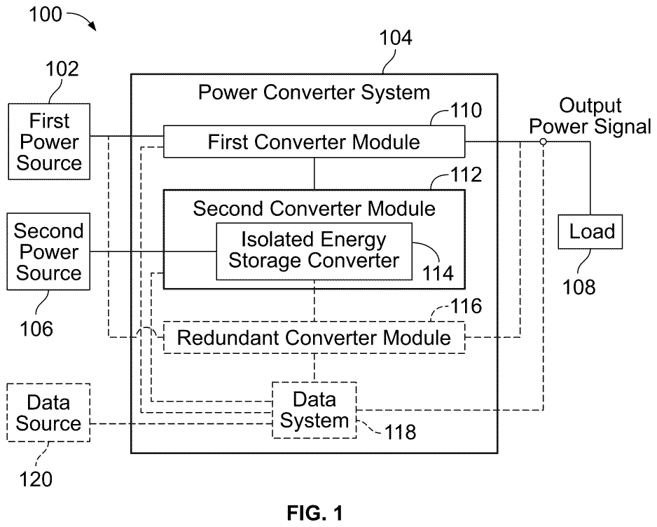

Referring now to FIG. 1, a block diagram of a power system 100 is illustrated, in accordance with an exemplary embodiment. It is noted that systems described herein including system 100, may be implemented as a single device, and/or as a plurality of devices, e.g., as described herein. The power system 100 includes a first power or energy source 102, a power converter or supply system 104, a second power or energy source 106, and a load 108. The power converter system 104 may receive a first power signal from the first power source 102 and/or a second power signal from the second power source 106. The first power signal may be an AC power signal operating at a standard voltage and frequency, such as 120 or 240 volts AC at 60 Hz, and the second power signal may be a DC power signal. The first power source 102 may be or include a utility grid, a generator, or any other suitable source of power or energy. The second power source 106 may be or include any suitable power source, such as one or more Distributed Energy Resources (DERs). The DERs may include energy technologies that generate and/or store power or energy. For example, a DER may include one or more batteries, fuel cells, solar cells, generators, and/or any other suitable power or energy sources.

The power converter system 104 may be configured to generate an output power signal based on the first power signal received from the first power source 102 and/or the second power signal received from the second power source 106. As shown in FIG. 1, the power converter system 104 includes a first converter module or unit 110 and a second converter module or unit 112. It is noted various aspects referred to as a module or unit include circuitry and/or other structure suitable for implementing the described functionality, as expressly described and/or as would be understood by those of skill in the art. The first converter module 110 may be configured to receive the first power signal from the first power source 102 and the second converter module 112 may be configured to receive the second power signal from the second power source 106. The second converter module 112 may include an isolated energy storage converter 114. The isolated energy storage converter 114 may generate a DC voltage based on power received from the second power source 106 and may provide the DC voltage to the first converter module 110 to produce the output power signal. The isolated energy storage converter 114 may deliver the partial or total power required for producing the output power signal for the load 108. The isolated energy storage converter 114 may also receive a DC voltage from the first converter module 110 for charging the second power source 106. For example, the first converter module 110 may provide a DC voltage to the isolated energy storage converter 114 to charge a battery associated with the second power source 106. In some implementations isolated energy storage converter 114 provides galvanic isolation of its input power source from its output power.

The power converter system 104 may provide the output power signal to the load 108. The output power signal may be a power signal as appropriate for powering the load 108. In particular, the load 108 may be configured to normally operate on standard utility power, in which case the output power signal may have the same characteristics as a utility power signal. It will be recognized that the output signal may have any suitable AC voltage and/or power level to power the load 108. Further, the output power signal may be a DC voltage at one or more predetermined levels or a non-standard AC voltage. In addition, the output power signal generated by the power converter system 104 can have any waveshape including bi-polar and unipolar voltages. For example, the output power signal can include sinusoidal AC with standard 50 Hz/60 Hz frequencies, such as frequencies between 0.1 Hz to 10 Hz, a unipolar DC voltage either positive or negative, or any frequency between standard 50/60 Hz and DC. As such, the power converter system 104 can generate any desirable output power signal to power the load 108 and can dynamically change the characteristics of the output power signal without changing or replacing any of the physical hardware of the power converter system 104.

The load 108 of the power system 100 may be or form a part of a residential service, e.g., including one or more of digital televisions (DTV) services, set top boxes (STB) services, cable networks, cable modem services, cable television systems, Wi-Fi services, and/or telephone services. The load 108 may also be or form a part of a commercial service, e.g., including one or more of cable modem services, cable networks, security systems, IP/PBX systems, and/or point of sale services. Further, the load 108 may be or form a part of a physical layer (e.g., OSI MODEL—Layer 1) for implementing basic functions (e.g., Tx/Rx, modulations, signals) of a data communications system. Other examples of loads that may form the load 108 include Wireless AP (e.g., Wi-Fi, Lora Gateway, LTE-M, NB-IoT, and Zigbee), surveillance cameras, small cells (e.g., 4G and/or 3G cellular), 5G cellular, remote physical layer (PHY), data backhaul gateways, outdoor remote utility power analyzers, luminaries/lights, roadway traffic control systems, and/or sensors, etc.

The power converter system 104 of the power system 100 may provide on-line, standby, and/or other modes of operation. In a normal mode of operation, power may flow from the first power source 102 through the first converter module 110 to the load 108. During standby operations, power may flow from the second power source 106 through the second converter module 112 to the first converter module 110 for generating the output power signal to power the load 108. As shown in FIG. 1, the second converter module 112 may be located external to the first converter module 110 and connected to the first converter module 110 by one or more cables or conductors. In some embodiments, the second converter module 112 may be included or housed within the first converter module 110. For example, the first converter module 110 may be or include an enclosure that can house or contain the second converter module 112.

The power converter system 104 may also include one or more redundant converter modules 116 (one being shown). For example, the redundancy of the first converter module 110 can be N+1 or N+N. The redundant converter module 116 may provide an additional output power signal to the load 108 which can be combined with the output power signal of the first converter module 110 to provide the power required by the load 108. In some embodiments, the redundant converter module 116 may provide the total power required by the load 108, via an output power signal, upon a failure or outage of the first converter module 110. The redundant converter module 116 may be coupled in parallel with the first converter module 110 between the first power source 102 and the load 108. Further, the redundant converter module 116 may be constructed and operate substantiality similar to the first converter module 110. The redundant converter module 116 may also be coupled to the second converter module 112 via a bus or cable. The power system 100 may also include additional second converter modules (not shown) that may be coupled to the first converter module 110.

Further, the power system 100 may include a data system 118 for transmitting and/or communicating data between a data source 120, internal power components or devices, and the load 108 through any suitable wireless, wired, and/or fiber optic data transmission system. In some implementations, the data system 118 may include a DOCSIS cable modem, Wi-Fi or other wireless access point, a cellular modem, and/or a LORA gateway. In some embodiments, the data system 118 may be included or housed within the first converter module 110 or the second converter module 112.

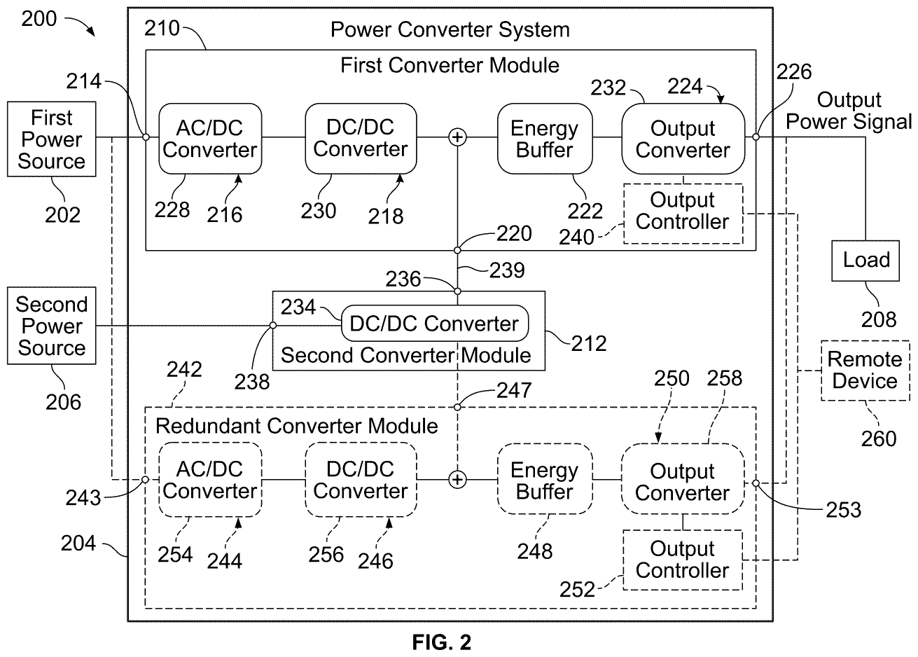

FIG. 2 illustrates a block diagram of the components of a power converter or supply system 200, in accordance with an exemplary embodiment. The power converter system 200 may be operatively coupled to a first power or energy source 202 and to a second power or energy source 206. The power converter system 200 may also be operatively coupled to a load 208. The power converter system 200 may be configured to receive a first power signal from the first power source 202 and/or a second power signal from a second power source 206. The first power signal may be an AC power signal operating at a standard voltage and frequency, such as 120 or 240 volts AC at 60 Hz, and the second power signal may be a DC power signal. The first power source 202 may be or include a utility grid, a generator, or any other suitable source of power or energy. The second power source 206 may be or include an energy storage system. The energy storage system may include one or more batteries, fuel cells, solar cells, generators, and/or any other suitable power or energy device.

The power converter system 200 may be configured to generate an output power signal based on the first power signal received from the first power source 202 and/or the second power signal received from the second power source 206. As shown in FIG. 2, the power converter system 200 includes a first converter module 210 and a second converter module 212. The first converter module 210 may include an input port or terminal 214, an AC/DC stage 216, an isolated DC/DC stage 218, a port or terminal 220, an energy buffer 222, an output stage 224, and an output port or terminal 226. The AC/DC stage 216 may include an AC/DC converter 228 and the isolated DC/DC stage 218 may include a DC/DC converter 230. The isolated DC/DC stage 218 may be configured to ensure any line disturbances are not passed on to the load 208. The output stage 224 of the first converter module 210 may include an output converter 232.

The first converter module 210 may be configured to receive, via the input port 214, an input power signal from the first power source 202. The input port 214 enables the first converter module 210 to be detachably coupled to the first power source 202 via a cable or connector. A protection coupling circuit (not shown) may allow for the first converter module 210 to be safely coupled to the first power source 202 while the first power source 202 is active. The input port 214 is also coupled to the input of the AC/DC converter 228 of the first converter module 210.

The AC/DC converter 228 may be configured to receive the input power signal from the first power source 202 and convert the input power signal to a first DC voltage. The AC/DC converter 228 may be or include a totem pole power factor corrected (PFC) circuit as further described below. In some embodiments, the AC/DC converter 228 may be or includes a rectifier circuit or any other suitable circuitry to convert an AC signal to a DC voltage. The AC/DC converter 228 may be configured to output the first DC voltage to the DC/DC converter 230 of the first converter module 210.

The input of the DC/DC converter 230 may be coupled to the output of the AC/DC converter 228. The DC/DC converter 230 may receive the first DC voltage from the AC/DC converter 228 and convert the first DC voltage to a second DC voltage. The output of the DC/DC converter 230 may be coupled to the energy buffer 222 and the DC/DC converter 230 may output the second DC voltage to the energy buffer 222. The energy buffer 222 may be configured to isolate voltage ripples occurring on any of the ports of the first converter module 210. The energy buffer 222 may be or include one or more capacitors (e.g., one or more high voltage capacitors or supercapacitors) as further described below. The DC/DC converter 230 may also provide the second DC voltage to the second converter module 212.

The second converter module 212 may include a DC/DC converter 234, a first port or terminal 236, and a second port or terminal 238. The first port 236 may be coupled to the DC/DC converter 234 and may enable the second converter module 212 to be detachably coupled to the port 220 of the first converter module 210 via a bus or cable 239. Protection coupling circuits (not shown) may allow for the first converter module 210 to be safely coupled to the second converter module 212. As further described below, the DC/DC converter 234 may receive a DC voltage from the DC/DC converter 230 of the first converter module 210 via the bus 239. The first port 236 and the port 220 may each be or include a high voltage DC port or any other suitable port.

The second port 238 of the second converter module 212 may enable the second converter module 212 to be detachably coupled to the second power source 206. A protection coupling circuit (not shown) may allow for the second converter module 212 to be safely coupled to the second power source 206 while the second power source 206 is active. The second port 238 may be coupled to the DC/DC converter 234 and the DC/DC converter 234 may receive an input power signal from the second power source 206. The second power source 206 may provide the input power signal to the DC/DC converter 234 at a particular voltage. The DC/DC converter 234 may convert the input power signal to a DC voltage. The DC/DC converter 234 may output the DC voltage to the energy buffer 222 of the first converter module 210,

The DC/DC converter 234 of the second converter module 212 may also receive a DC voltage from the DC/DC converter 230 of the first converter module 210 to charge the second power source 206. For example, the DC/DC converter 234 may use power received from the first converter module 210 to charge a battery associated with the second power source 206. The DC/DC converter 234 of the second converter module 212 may be or include a bi-directional isolated energy storage converter such as a Dual Active Bridge (DAB) as further described below, In some embodiments, the DC/DC converter 234 may be or include an LLC converter, a CLLLC converter, a Phase-Shifted Full Bridge (PSFB) converter, or any other suitable circuitry.

The energy buffer 222 of the first converter module 210 may receive a DC voltage from the DC/DC converter 230 of the first converter module 210 and a DC voltage from the DC/DC converter 234 of the second converter module 212. The energy buffer 222 may regulate the DC voltage received from the DC/DC converter 230 and the DC voltage received from the DC/DC converter 234 of the second converter module 212. The energy buffer 222 may output a DC voltage to the output converter 232.

The input of the output converter 232 may be coupled to the energy buffer 222 and may receive a DC voltage from the energy buffer 222. The output converter 232 may convert the DC voltage from the energy buffer 222 into an output power signal. The output power signal can output either AC or DC power signal as appropriate for powering the load 208. In particular, the load 108 may be configured to normally operate on standard utility power, in which case the output power signal may have the same characteristics as a utility power signal. As such, the output converter 232 may convert a DC signal from the energy buffer 222 into an AC voltage. Further, the output converter 232 may be configured to output any suitable AC voltage or power. In some embodiments, the load 208 may be configured to operate based on a DC voltage at one or more predetermined levels or a non-standard AC voltage. As such, the output converter 232 can generate a suitable DC signal. For example, the output converter 232 may generate a 150V switched DC signal to reduce losses on long/high impedance power distribution lines of a broadband network. The output converter 232 may provide the output power signal (e.g., DC signal) to the output port 226. In some embodiments, a protection coupling circuit may allow the output converter 232 to be coupled with the output port 226. The output port 226 may enable the first converter module 210 to be detachably coupled to the load 208.

The first converter module 210 may also include an output controller 240. The output controller 240 may be configured to control the output profile of the output converter 232. The output controller may be or include a processor or any other computing device. The output controller 240 may interface with a remote device 260 through any serial or parallel communication. The output controller 240 may be configured to receive commands from the remote device 260. Based on the commands received from the remote device 260, the output controller 240 may set or control the profile of the output power signal generated by the output converter 232. For example, the output control 240 may configure the output converter 232 to generate a bi-polar and uni-polar output power signal that may be supplied to the load 208. The remote device 260 may be or include a wired or wireless computing device or any other suitable communication device.

The power converter system 200 may also include a redundant converter module 242. The redundant converter module 242 may be constructed and operated similar to the first converter module 210. For example, the redundant converter module 242 may include the same or similar components as the first converter module 210, such as an input port or terminal 243, an AC stage 244, a DC stage 246, a port or terminal 247, an energy buffer 248, an output stage 250, an output controller 252, and an output port or terminal 253. The AC stage 244 may include an AC/DC converter 254, the DC stage 246 may include a DC/DC converter 256, and the output stage 250 may include an output converter 258. In some embodiments, the power converter system 200 may not have an AC/DC converter stage and/or DC/DC stage 246 and may not be coupled to the first power source 202 Further, the power converter system 200 may include a data system as described above for transmitting information to the load 208.

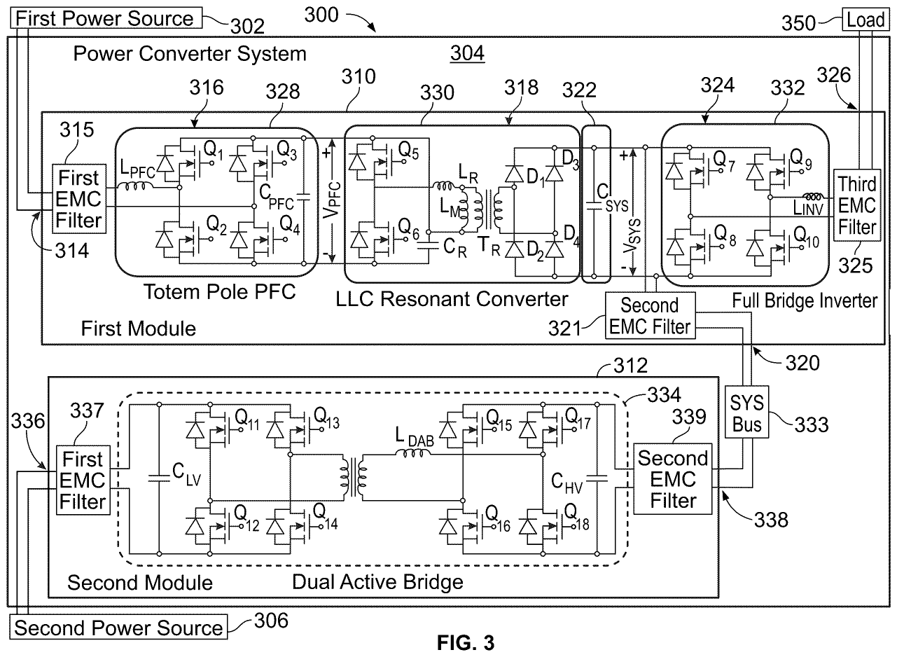

FIG. 3 illustrates a schematic circuit diagram of a power converter system 300, in accordance with an exemplary embodiment. The power converter system 300 is configured to receive power from a first power or energy source 302 and/or a second power or energy source 306. The power converter system 300 may be configured to generate an output power signal based on the power received from the first power source 302 and/or the second power source 306. The first power source 302 may be a utility grid, a generator, or any other suitable power or energy source. The second power source 306 may be or include one or more batteries, such as a 36V battery. In some embodiments, the second power source may include one or more fuel cells, solar cells, generators (e.g., DC generators), or any other suitable power or energy device.

As shown in FIG. 3, the power converter system 300 includes a first module 310 and a second module 312. The first module 310 may be or include an AC module and the second module 312 may be or include a DC module. The AC module may include an input port or terminal 314, a first EMC filter 315, an AC stage 316, a DC stage 318, a port or terminal 320, a second EMC filter 321, an energy buffer 322, an output stage 324, a third EMC filter 325, and an output port or terminal 326. The AC stage 316 may include an AC/DC converter circuit 328, the DC stage 318 may include a DC/DC converter circuit 330, and the output stage 324 may include an output converter circuit 332. The input port 314 may enable the first module 310 to be detachably coupled to the first power source 302 and may receive an input power signal from the first power source 302. The first power source 302 may be a utility grid, a generator, or any other suitable power or energy source.

The input port 314 of the first module 310 may be coupled to the first EMC filter 315. The first EMC filter 315 may filter out unwanted frequencies and/or voltages and prevent propagation of undesired electromagnetic interference to the first power source 302. The input. power signal may be in the form of an AC voltage. The first EMC filter 315 may be coupled to the AC/DC converter circuit 328.

The AC/DC converter circuit 328 may receive the input power signal via the first EMC filter 315 and may convert the input power signal to a first DC voltage while drawing sinusoidal current in-phase with the sinusoidal voltage of the first power source 302. The AC/DC converter circuit 328 may be or include a totem pole Power Factor Correction (PFC) circuit. As shown in FIG. 3, the totem pole PFC circuit may be or include an inductor L_{PFC}, four transistors Q₁, Q₂, Q₃, Q₄, and a capacitor C_{PFC}. The four transistors Q₁, Q₂, Q₃, Q₄ may be or include metal oxide-semiconductor field effect transistors (MOSFETs). The output of the totem pole PFC circuit may be coupled to the DC/DC converter circuit 330 and may output the first DC voltage to the input of the DC/DC converter circuit 330 of the first module 310.

The DC/DC converter circuit 330 may receive the first DC voltage from the AC/DC converter circuit 328 and may convert the first DC voltage to a second DC voltage. The DC/DC converter circuit 330 may be or include an LLC resonant converter circuit. As shown in FIG. 3. the LLC resonant converter circuit may be or include two transistors Q₅, Q₆, two capacitors C_{R}. two inductors L_{M}, L_{R}, a transformer T_{R}, and four diodes D₁, D₂, D₃, D₄. The two transistors Q₅, Q₆may be or include MOSFETs. The output of the LLC resonant converter circuit may be coupled to the energy buffer 322 and may output the second DC voltage to the energy buffer 322 of the first module 310. Energy buffer 322 may be or include a capacitor C_{SYS}.

The energy buffer 322 may receive the DC voltage from the DC/DC converter circuit 330 of the first module 310 and may regulate the energy of the DC voltage. The energy buffer 322 may also receive a DC voltage from the DC/DC converter circuit 334 of the second module 312 as further described below. The energy buffer 322 may regulate the energy of the DC voltage received from the DC/DC converter circuit 334. The energy buffer 322 may provide a DC voltage V_{SYS} to the input of the output converter circuit 332.

The DC/DC converter circuit 330 may also provide the DC voltage V_{SYS} to the second EMC filter 321. The second EMC filter 321 may receive the DC voltage V_{SYS} from the DC/DC converter circuit 330 and may further filter the regulated DC voltage. The second EMC filter 321 may provide the filtered DC signal to the second EMC filter 339 of the second module 312 via a bus or cable 333.

The second module 312 may be detachably coupled to the first module 310 via the bus 333. The second module 312 may include a DC/DC converter circuit 334, a first port or terminal 336, a first EMC filter 337, and a second port or terminal 338, and a second EMC filter 339. The first port 336 of the second module 312 may enable the second module 312 to be detachably coupled to the second power source 306. The first port 336 of the DC module may also be coupled to the first EMC filter 337. The first EMC filter 337 may be coupled between the first port 336 and the DC/DC converter circuit 334 and may receive an input power voltage from the second power source 306. The input power signal voltage may be in the form of a DC voltage and the second power source 306 may be or include a battery, such as a 36V battery. The first EMC filter 337 may filter out unwanted frequencies and/or voltages and prevent propagation of undesired electromagnetic interference to the second power source 306.

The first EMC filter 337 may also be coupled to the DC/DC converter circuit 334 and may output a filtered input power voltage to the input of the DC/DC converter circuit 334. The DC/DC converter circuit 334 may receive the filtered input power voltage and may convert the input power voltage to a DC voltage. The DC/DC converter circuit 334 may be bidirectional and may also convert a DC voltage received from the first module 310 to a DC battery voltage appropriate for charging the second power source 306. As depicted in FIG. 3 the DC/DC converter circuit is a Dual Active Bridge (DAB) circuit. The DAB circuit may be or include two capacitors C_{CV}, C_{HV}, an inductor L_{DAB}, a transformer, and eight transistors Q₁, Q₁₂, Q₁₃, Q₁₄, Q₁₅, Q₁₆, Q₁₇, Q₁₃. The eight transistors Q₁, Q₁₂, Q₁₃, Q₁₄, Q₁₅, Q₁₆, Q₁₇, Q₁₈ may be or include MOSFETs. The output of the DAB circuit may be coupled to the second EMC filter 339 and may filter the DC voltage. The DAB circuit may output a filtered DC voltage and apply the filtered DC voltage to the second port 338. The filtered DC voltage may be supplied to the second EMC filter 321 of the first module 310 via the bus 333. The second EMC filter 321 may further filter the DC voltage and may output the filtered DC voltage to the Energy buffer 322 of the first module 310.

The energy buffer 322 may receive the filtered DC voltage from the DC/DC converter circuit 334 of the second module 312 and/or a DC voltage from the DC/DC converter circuit 330 of the first module 310. The energy buffer 322 may be coupled to the input of the output converter 232 of the first module 310.

The output converter circuit 332 may receive the DC voltage from the energy buffer 322 and may convert the DC voltage into an output power signal appropriate for powering a load 350. The output power signal can output either AC or DC power signal as appropriate for powering the load 350. In particular, the load 350 may be configured to normally operate on standard utility power, in which case the output power signal may have the same characteristics as a utility power signal. As such, the output converter circuit 332 may convert a DC signal from the energy buffer 222 into an AC output power signal. Further, the output converter circuit 332 may convert the DC signal into any suitable AC voltage or power. In some embodiments, the load 350 may be configured to operate based on a DC voltage at one or more predetermined levels or a non-standard AC voltage. As such, the output converter circuit 332 can generate a suitable output DC power voltage. For example, the output converter circuit 332 may generate a 150V switched DC signal to reduce losses on the long/high impedance power distribution lines of a broadband network. In some examples, the output converter circuit is capable of converting the DC voltage into an AC power signal that is applied to the load 350.

In some embodiments, the first module 310 may include an output controller (not shown). The output controller may be configured to control the output profile of the output converter circuit 332. The output controller may be or include a processor or any other computing device. The output controller may be configured to receive commands from a remote device (not shown). Based on the commands received from the remote device, the output controller may set or control the profile of the output power signal generated by the output converter circuit 332. For example, the output controller may configure the output converter circuit 332 to generate a bi-polar and uni-polar output power signal that may be supplied to the load 350. In other embodiments, the output controller may configure the output converter circuit 332 to produce a suitable AC or DC output signal. The remote device may be or include a wired or wireless computing device or any other suitable communication device to communicate with the output controller.

The output converter circuit 332 may be or include a full bridge inverter circuit. As shown in FIG. 3, the full bridged inverter circuit may be or includes an inductor Liny and four transistors Q₇, Q₈, Q₁₀. The four transistors may be or include MOSFETs. The output of the full bridge inverter circuit may be coupled to the third EMC filter 325 and may supply the output power signal to third EMC filter 325 of the first module 310. The third EMC filter 325 may filter the output power signal and prevent propagation of undesired electromagnetic interference to the load 350. The output power signal may be provided to the output port 326 of the first module 310 via the third EMC filter 325. The output port 326 enables the first module 310 to be detachably coupled to the load 350 and thus to allow the output power signal generated by the first module to be supplied to the load 350. Further, the first module 310 of the power converter system 300 may include an output controller (e.g., output controller 240) as described above.

The description of the different advantageous arrangements has been presented for purposes of illustration and description, and is not intended to be exhaustive or limited to the examples in the form disclosed. Many modifications and variations will be apparent to those of ordinary skill in the art. Further, different advantageous examples describe different advantages as compared to other advantageous examples. The example or examples selected are chosen and described in order to best explain the principles of the examples, the practical application, and to enable others of ordinary skill in the art to understand the disclosure for various examples with various modifications as are suited to the particular use contemplated.

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent to another element without being in contact with that element.

As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

By the term “substantially” and “about” used herein, it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

While apparatus has been described with reference to certain examples, it will be understood by those skilled in the art that various changes can be made and equivalents can be substituted without departing from the scope of the claims. Therefore, it is intended that the present apparatus not be limited to the particular examples disclosed, but that the disclosed apparatus include all embodiments falling within the scope of the appended claims.

What is claimed is:

1. A power converter apparatus for providing power to a load comprising:
a first converter apparatus comprising:
a first port configured to be detachably coupled to a first power source;
a first converter, operatively coupled to the first port, configured to convert power from the first power source to a first DC voltage;
a second converter, operatively coupled to the first converter, configured to convert the first DC voltage to a second DC voltage;
an energy buffer, operatively coupled to the second converter, configured to regulate the second DC voltage;
an output converter, operatively connected to an energy buffer, configured to generate an output power signal based on the regulated second DC voltage, wherein the output power signal is an AC signal or a DC signal; and
a second port coupled to the output converter, wherein the second port is configured to be detachably coupled to the load.

2. The power converter apparatus of claim 1, wherein the first power source comprises an AC power source.

3. The power converter apparatus of claim 2, wherein the AC power source comprises a power grid.

4. The power converter apparatus of claim 1, wherein the load comprises at least one of a broadband network, a cable television network, a communication network, a cable modem network, or a load device operating on an AC or DC voltage.

5. The power converter apparatus of claim 1, further comprising an output controller operatively coupled to the output converter and to a remote device, wherein the output controller is configured to cause the output converter to change the characteristics of the output power signal based on commands from the remote device.

6. The power converter apparatus of claim 1, wherein the first converter comprises a power factor corrector circuit.

7. The power converter apparatus of claim 1, wherein the second converter comprised a resonant converter, an isolated resonant converter, or an isolated DC-DC converter.

8. The power converter apparatus of claim 1, wherein the energy buffer comprises one or more capacitors.

9. The power converter apparatus of claim 1, wherein the output converter comprises a full bridge circuit or an inverter circuit.

10. The power converter apparatus of claim 1, further comprising a redundant power converter, wherein the redundant power converter is coupled in parallel with the first converter apparatus between the first power source and the load.

11. The power converter apparatus of claim 10, wherein the redundant power converter comprises at least one of a first converter, a second converter, an energy buffer, or an output converter.

12. The power converter apparatus of claim 1, further comprising a data system coupled between the load and a data source.

13. The power converter apparatus of claim 1, further comprising:
a second converter apparatus comprising:
a first port configured to be detachably coupled to a second power source;
a converter, operatively coupled to the first port, configured to convert power from the second power source to a DC voltage; and
a second port configured to be coupled to a third port of the first converter apparatus.

14. The power converter apparatus of claim 13, wherein the second power source comprises a DC power source.

15. The power converter apparatus of claim 14, wherein the DC power source comprises a battery or an energy storage component.

16. The power converter apparatus of claim 13, further comprising a bus coupled between the second port of the second converter apparatus and the third port of the first converter apparatus.

17. The power converter apparatus of claim 13, wherein the power converter apparatus is configured to operate in at least one of a first mode, a second mode, or a third mode, wherein the first mode supplies power to the load from the first power source, wherein the second mode supplies power to the load from the second power source, and wherein the third mode supplies power to the load from the first and second power source.

18. A power converter apparatus for providing power to a load comprising:
a first converter apparatus comprising:
an energy buffer configured to output a first DC voltage based on an input DC voltage;
an output converter, operatively coupled to the energy buffer, configured to generate an output power signal based on the first DC voltage, wherein the output power signal is an AC signal or a DC signal; and
a first port operatively coupled to the energy buffer; and
a second converter apparatus comprising:
a converter configured to converter an input power voltage to a second DC voltage; and
a first port configured to be coupled to the first port of the first converter apparatus via a bus.

19. The power converter apparatus of claim 18, wherein the energy buffer is further configured to receive the second DC voltage, wherein the input power source comprises a DC power source, and wherein the load comprises at least one of a broadband network, a cable television network, or a cable modem network.

20. The power converter apparatus of claim 18, further comprising an output controller operatively coupled to the output converter, wherein the output controller is configured to cause the output converter to change the output power signal between the AC signal and the DC signal.
